(19) United States
(12) Patent Application Publication
(10) Pub. No.: US 2010/0149614 A1
(43) Pub. Date: Jun. 17, 2010

(54) OPTICAL SCANNER

(75) Inventors: MING-CHIEH CHOU, Tainan City (TW); Pin Chang, Hsinchu City (TW); Hung-Chung Li, Hualien County (TW); Chung-De Chen, Miaoli County (TW)

Correspondence Address: WPAT, PC;INTELLECTUAL PROPERTY ATTORNEYS, 7225 BEVERLY ST., ANNANDALE, VA, 22003, US

(73) Assignee: Industrial Technology Research Institute, Hsin-Chu (TW)

(21) Appl. No.: 12/566,079

(22) Filed: Sep. 24, 2009

(30) Foreign Application Priority Data
Dec. 16, 2008 (TW) 97/148.896

(51) Int. Cl. G02B 26/10

(52) U.S. Cl. 359/200.7

(57) ABSTRACT

An optical scanner including a substrate, a driving component, and an optical reflector is provided. The driving component is disposed on the substrate and has a first hole. The driving component can swing about a first axis by a time-varied magnetic force. The optical reflector has a reflective surface and is disposed in the first hole. The optical reflector can swing about a second axis by a Lorentz force. The first axis is essentially perpendicular to the second axis. The first axis and the second axis are both essentially parallel to the reflective surface.

### FIELD OF THE INVENTION

The present invention relates to an optical scanner, and more particularly, to an optical scanner driven by time-varied magnetic forces.

### BACKGROUND OF THE INVENTION

In the applications of the micro-electro mechanical system (MEMS) technology, there is an advanced optical component, referring as the micro scanning mirror, being developed which is adapted for devices, such as scanner, bar code machine, projector, and so on.

Currently, there is already a variety of such micro scanning mirror being applied in projectors. One of which is the raster-scanned micro scanning mirror that is usually seen in the applications of virtual projector and laser projector.

It is noted that the raster-scanned micro scanning mirror usually uses a mirror device for reflecting light beams emitted from its light source. As the mirror device is designed to swing about two axes that are mutually perpendicular to each other, raster scanned in the horizontal and vertical directions can be achieved by the use of the beams reflected thereby. Moreover, as the beams reflected by the mirror device in the horizontal/vertical direction raster scanning are projected to a screen, they are used for forming images accordingly.

### SUMMARY OF THE INVENTION

The present invention provides an optical scanner, comprising: a substrate, a driving component, and an optical reflector. The driving component is disposed on the substrate and has a first hole. The driving component can swing about a first axis by a time-varied magnetic force. The optical reflector has a reflective surface and is disposed in the first hole. The optical reflector can swing about a second axis by a Lorentz force. The first axis is essentially perpendicular to the second axis. The first axis and the second axis are both essentially parallel to the reflective surface.

As the optical reflector is driven to swing about the first and the second axes P1, P2 by the time-varied magnetic force and the Lorentz force, the beams reflected by the optical reflector can be used in a vertical scanning as well as a horizontal scanning so as to project an image on a screen.

Further scope of applicability of the present application will become more apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given herein below and the accompanying drawings which are given by way of illustration only, and thus are not limitative of the present invention and wherein:

FIG. 1A is a three-dimensional diagram showing an optical scanner according to an embodiment of the invention.

FIG. 1B and FIG. 1C are schematic diagrams respectively showing how an optical reflector in the optical scanner of FIG. 1A is driven to swing.

FIG. 1D is a sectional view of the optical scanner shown in FIG. 1A.

FIG. 2 is a sectional view of an optical scanner according to another embodiment of the invention.

FIG. 3 is a three-dimensional diagram showing an optical scanner according to yet another embodiment of the invention.

FIG. 4A is a top view of an optical scanner according to further another embodiment of the invention.

FIG. 4B is an I-I sectional view of FIG. 4A.

FIG. 5A is a top view of an optical scanner according to further another embodiment of the invention.

FIG. 5B is a J-J sectional view of FIG. 5A.

### DESCRIPTION OF THE EXEMPLARY EMBODIMENTS

For your esteemed members of reviewing committee to further understand and recognize the fulfilled functions and structural characteristics of the invention, several exemplary embodiments cooperating with detailed description are presented as the follows.

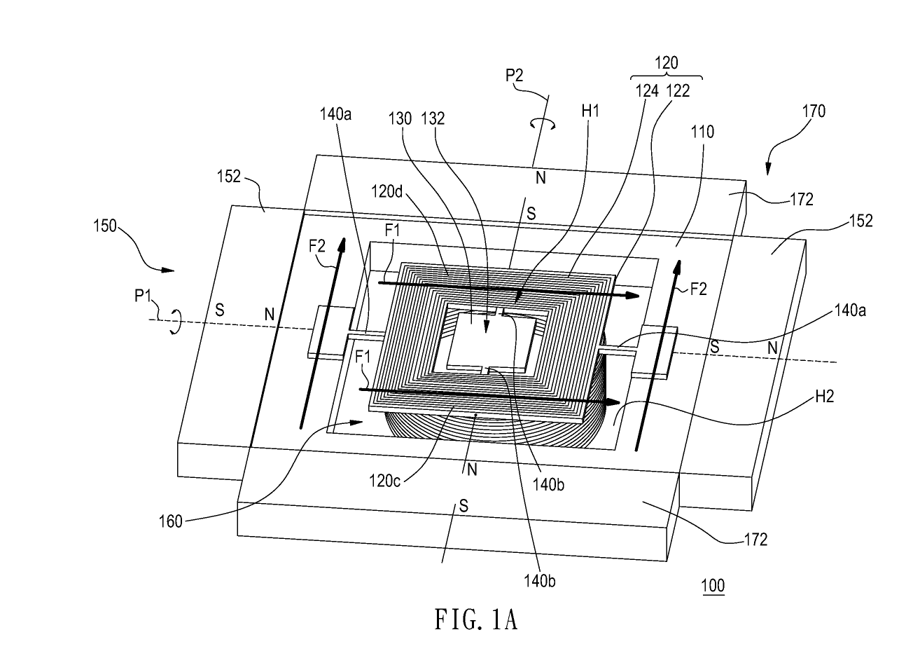

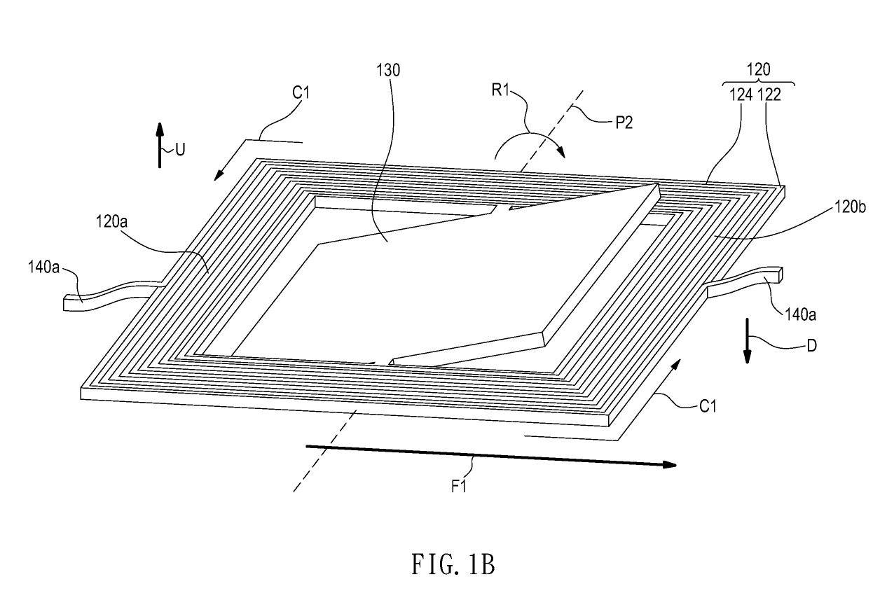

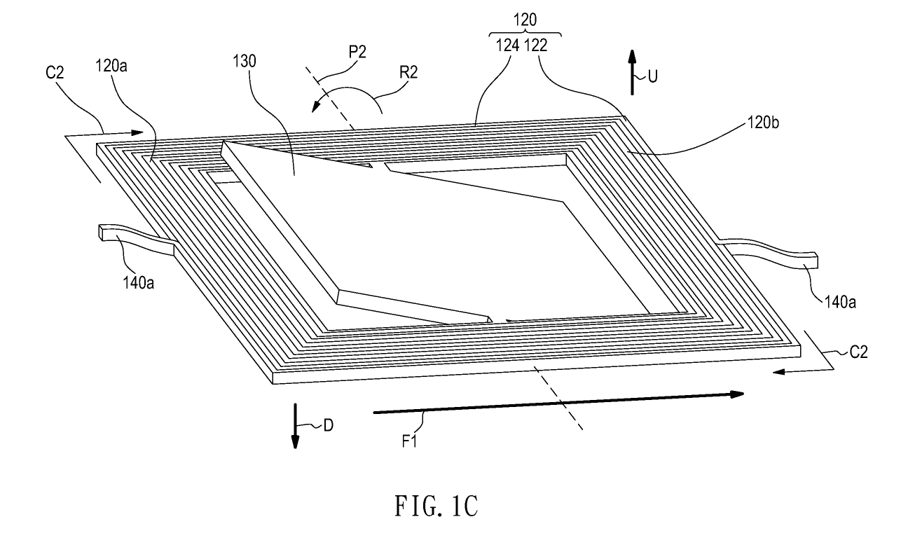

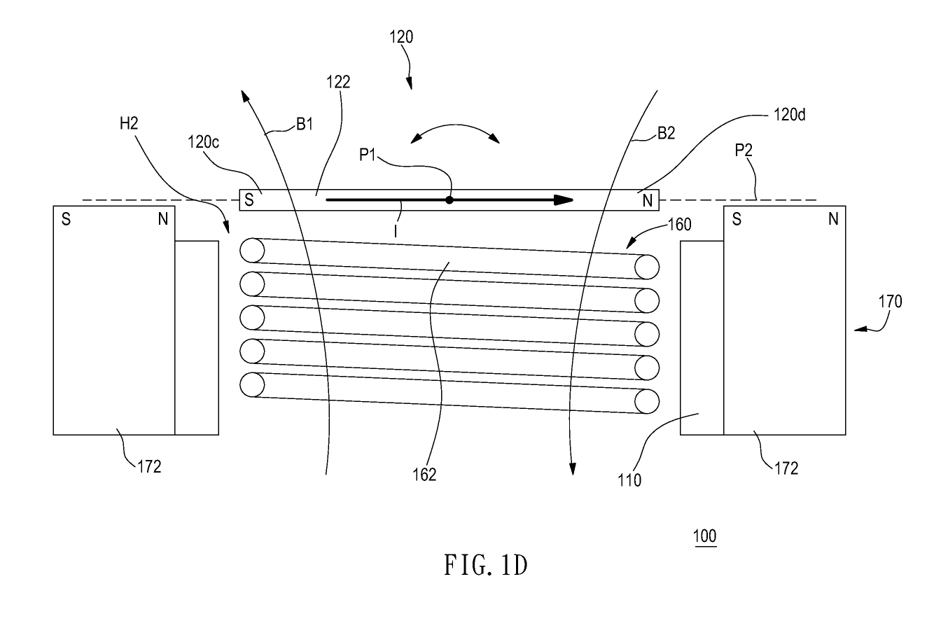

Please refer to FIG. 1A, which is a three-dimensional diagram showing an optical scanner according to an embodiment of the invention. In FIG. 1A, the optical scanner 100, being adapted for a projector, such as a virtual projector or a laser projector, includes a substrate 110, a driving component 120 and an optical reflector 130.

The driving component 120 is disposed on the substrate 110 and is configured with a first hole H1. It is noted that the substrate 110 can be a silicon substrate, a glass substrate or a circuit board and is further capable of being configured with a second hole H2, In an exemplary, the first hole H1 and the second hole H2 can be manufactured by the use of a lithograph and etching process. In addition, the optical reflector 130 is designed to be received inside the first hole H1 that it is configured with a reflective surface 132 for reflecting beams emitted from the projector's light source, even if the beam is a laser beam.

As shown in FIG. 1A, the driving component 120 is designed to swing about a first axis P1 and the optical reflector 130 is designed to swing about a second axis P2, in which the first axis P1 is essentially perpendicular to the second axis P2; and the first axis P1 and the second axis P2 are both essentially parallel to the reflective surface 132.

As the driving component 120 is enabled to swing about the first axis P1 and the optical reflector 130 is enabled to swing about the second axis P2, the combination of the aforesaid swing driving component 120 and the swing optical reflector 130 is equivalent to that the optical reflector 130 is enable to swing about the first and the second axes P1, P2, and thereby, the projector is able to use the beams reflected by the reflective surface 132 of the optical reflector 130 in a vertical scanning process as well as a horizontal scanning process and thus form images on a screen of the projector.

In this embodiment, the driving component 120 is further comprised of a frame 122 and a coil circuit 124, in which the coil circuit 124 is disposed on the frame 122 while surrounding the first hole H1, as the frame 122 is disposed at a position corresponding to the second hole H2. For instance, the frame 122 can be received inside the second hole H2, or can be disposed over the second hole H2. Moreover, the coil circuit 124 can be formed by electroplating, lithography, or etching.

The optical scanner 100 further comprises a pair of first arms 140a and a pair of second arms 140b. It is noted that each of the first arms 140a is disposed coaxially to the first axis P1 to be used for connecting the frame 122 to the substrate 110, by that the driving component 120 is able to swing about the two first arms 140a as the pair of the first arms 140a is able to function as the first axis P1. Similarly, each of the second arms 140b is disposed coaxially to the second axis P2 to be used for connecting the frame 122 to the optical reflector 130, by that the optical reflector 130 is able to swing about the two second arms 140b since the second arms 140b are designed to function as the second axis P2.

The optical reflector 130 is driven to swing about the second axis P2 by a Lorentz force, In detail, the optical scanner 100 further comprises a driving magnetic field generator 150, capable of causing the Lorentz force to be generated at a position between the coil circuit 124 and the driving magnetic field generator 150 and thus enabling the optical reflector 130 to be driven to swing about the second axis P2 by the Lorentz force.

Generally, the driving magnetic field generator 150 includes a pair of first magnets 152, capable of generating a first magnetic filed F1 at a position between the same while enabling the direction of the first magnetic field F1 to be parallel with the first axis P1. In addition, the pair of the first magnets 152 is disposed in a manner that the opposite poles of the two are arranged near each other for attraction.

Taking the pair of first magnets 152 shown in FIG. 1A for example, the south pole of one first magnet 152 in the pair, i.e. the first magnet 152 disposed at the right of FIG. 1A, is arranged facing toward the north pole of another first magnet 152, i.e. the first magnet 152 disposed at the left of FIG. 1A. Moreover, the pair of the first magnets 152 are placed on the first axis P1 in a manner that the extending of the first axis P1 will pass the north pole of the left first magnet 152 and the south pole of the right first magnet 152, so that the direction of the first magnet field F1 generated between the two first magnets 152 will parallel with the first axis P1.

The coil circuit 124 is provided to be charged by electric current, especially the alternating current (AC). When the coil circuit 124 is subjected to an AC load, a Lorentz force will be caused by the effect between the coil circuit 124 and the first magnet field F1 to be used for enabling the optical reflector 130 to swing about the second axis P2.

FIG. 1B and FIG. 1C are schematic diagrams respectively showing how an optical reflector in the optical scanner of FIG. 1A is driven to swing. As the coil circuit 124 is subjected to an AC load, current will travel clockwisely and counterclockwisely in an alternating manner. The moment shown in FIG. 1B is when there is a current C1 in the coil circuit 124 that is traveling in a counterclockwise direction, by that as soon as the counterclockwise current C1 travel passing the two opposite sides 120a, 120b of the driving component 120, the reaction between the current C1 and the first magnet field F1 will cause a Lorentz force to be generated.

Consequently, by the driving of the Lorentz force, the side 120a will be forced to move upward in the direction indicated by the arrow U while another side 120b will be forced to move downward in the direction indicated by the arrow D. Thereby, the frame 122 is driven to rotate in a direction indicated by the arrow R1. As the frame 122 is being driven to rotate, the first arms 140a connecting to the frame 122 will be twisted thereby, as shown in FIG. 1B.

On the other hand, FIG. 1C shows the moment when there is another current C2 in the coil circuit 124 that is traveling in a clockwise direction, by that as soon as the clockwise current C2 travel passing the two opposite sides 120a, 120b of the driving component 120, the reaction between the current C2 and the first magnet field F1 will cause another Lorentz force to be generated which will force the side 120a to move downward in the direction indicated by the arrow D and another side 120b to move upward in the direction indicated by the arrow U. Thereby, the frame 122 is driven to rotate in a direction indicated by the arrow R2. Similarly, as the frame 122 is being driven to rotate, the first arms 140a connecting to the frame 122 will be twisted thereby, as shown in FIG. 1C.

As the coil circuit 124 is subjected to the counterclockwise current C1 and the clockwise current C2 in an alternating manner, the frame 124 will be driven to rotate alternatively in the R1 and R2 direction by the two opposite Lorentz forces. Consequently, the swing of the frame 124 will cause the optical reflector 130 to swing about the second axis P2.

Please refer to FIG. 1D, which is a sectional view of the optical scanner shown in FIG. 1A. As shown in FIG. 1A and FIG. 1D, the driving component 120 can be driven to swing about the first axis P1 by a time-varied magnetic force.

In this embodiment, the optical scanner 100 further comprises: a first magnetic field generator 160, which is disposed under the driving component 120 inside the second hole H2 to be used for enabling a time-varied magnetic force to be generated at a position between the first magnetic field generator 160 and the driving component 120. It is noted that the first magnetic field generator 160 can be a coil, as shown in FIG. 1A and FIG. 1D.

In detail, when the first magnetic field generator 160 is subjected to an AC load, a time-varied magnet pole will be caused at an end 162 of the first magnetic field generator 160, that is, the magnetism of the end 162 will varied in time and switch between south pole and north pole. That is, the magnetism of the end 162 will changed form north to south and then from south to north alternatively, and thereby, there will be two opposite magnetic fields B1, B2 being generated in a manner that they are periodically alternating in time.

Moreover, there is an inner magnetic field I existed inside the frame 122, whose direction is parallel with the second axis P2. As the frame can be made of ferromagnetic material or a ferrimagnetic material, it can be magnetized can thus be configured with a pair of opposite magnet poles, by that the inner magnetic field I is enabled to exist inside the frame 122.

Taking the optical scanner shown in FIG. 1D for example which shows the moment when the inner magnetic field I is existed inside the frame 122 for causing the south pole at the side 120c and the north pole at the opposite side 120d, a time-varied magnetic force will be generated by reaction between the time-alternating magnetic fields B1, B2 and the two sides 120c, 120d following the time-varying magnetism of the end 162. As the two opposite magnetic fields B1, B2 are generated in a manner that they are periodically alternating in time, the end 162 will either attract the side 120c or another side 120d in an alternating manner, and thereby, the driving component 120 is driven top swing about the first axis P1.

In this embodiment, the magnetic field I is generated by magnetic field induction. In detail, the optical scanner 100 is further comprised of a second magnetic field generator 170, provided for generating a second magnetic filed F2 to be used for causing the internal magnetic field I by induction.

Generally, the second magnetic field generator 170 includes a pair of second magnets 172, capable of generating the second magnetic filed F2 at a position between the same. In addition, the pair of the second magnets 172 is disposed in a manner that the opposite poles of the two are arranged near each other for attraction. That is, the south pole of one second magnet 172 in the pair, i.e. the second magnet 172 disposed at the right of FIG. 1D, is arranged facing toward the north pole of another second magnet 172, i.e. the second magnet 172 disposed at the left of FIG. 1D. Moreover, the pair of the second magnets 172 are placed on the second axis P2 in a manner that the extending of the second axis P2 will pass the north pole of the left second magnet 172 and the south pole of the right second magnet 172, so that the direction of the second magnet field F2 generated between the two second magnets 172 will parallel with the second axis P2.

It is emphasized that the aforesaid ferromagnetic material for manufacturing the frame 122 includes metal, cobalt or nickel or any alloys thereof, such as permalloy. In addition, the aforesaid ferrimagnetic material can be any compound including ferrous ions, such as alloys or ceramics including Fe₃O₄.

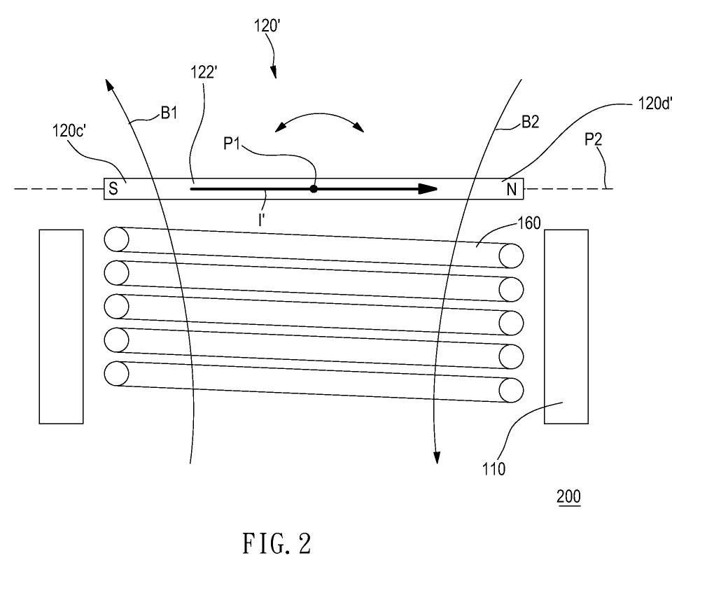

Please refer to FIG. 2, which is a sectional view of an optical scanner according to another embodiment of the invention. The optical scanner 200 shown in FIG. 2 comprises a substrate 110, a driving component 120′ and a first magnetic field generator 160. The optical scanner 200 is structured similar to the optical scanner 100 shown in FIG. 1D, but is different in that: the frame 122′ of the driving component 120′ is configured with a permanent magnetic field, i.e. the driving component 120′ is substantially a permanent magnet.

In detail, as the frame 122′ is made of a permanent magnet, there will be a south pole and a north pole being formed respectively at the opposite sides 120c′, 120d′ of the driving component 120′, and thereby, there will be an internal magnetic field I′ existed inside the frame 122′ without any induction for forming the same. It is noted that the direction of the internal magnetic field I′ is parallel with the second axis P2.

Similarly, the first magnetic field generator 160 will cause two opposite magnetic fields B1, B2 to be generated in a manner that they are periodically alternating in time. Accordingly, a time-varied magnetic force will be generated by reaction between the time-alternating magnetic fields B1, B2 and the two sides 120c′, 120d′ that is used for enabling the driving component 120′ to swing about the first axis P1.

As the frame 122′ is a permanent magnet that the internal magnetic field I′ can be formed without induction, the second magnetic field generator 170 required in the optical scanner 100 shown in FIG. 1D is no longer necessary in the optical scanner 200 and still there will be an internal magnetic field I′ existed in the frame 122′ to be used for driving the driving component 120′ to swing about the first axis P1.

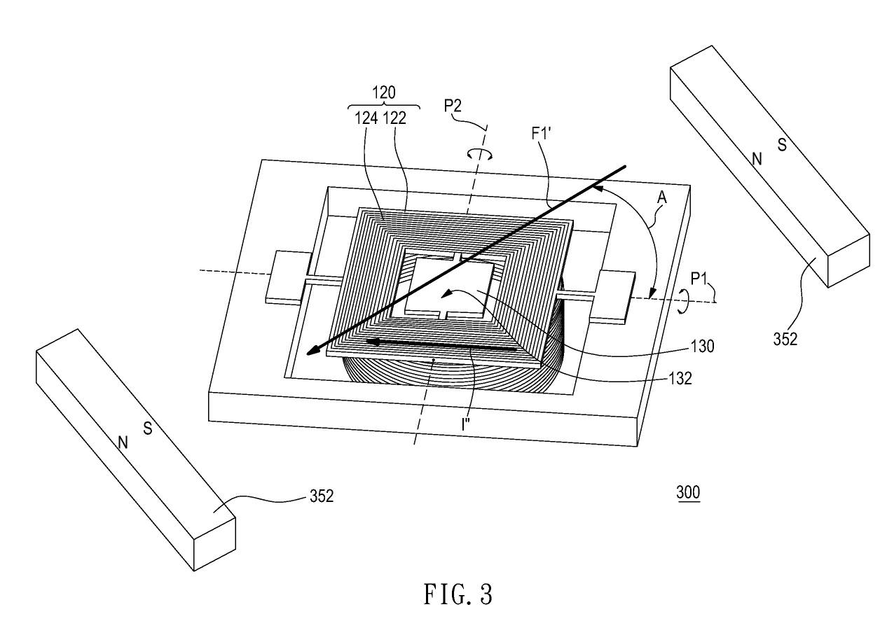

Please refer to FIG. 3, which is a three-dimensional diagram showing an optical scanner according to yet another embodiment of the invention. The optical scanner 300 shown in FIG. 3 is structured similar to the optical scanner 100 shown in FIG. 1D, but is different in that: the second magnetic field generator 170 used in the optical scanner 100 is not included in the optical scanner 300, and the first magnetic field F1′ caused by the driving magnetic field generator 350 in the optical scanner 300 is able to cause an internal magnetic filed I″ to be generated by induction on its own

In detail, a component of the first magnetic field F1′ is used for inducting the internal magnetic field I″ while the rest of the component is used for reacting with the current flowing in the coil circuit 124 for causing the Lorentz force. That is, the he first magnetic field F1′ is used not only for causing the Lorentz force, but also for causing the internal magnetic field I″. Thereby, the driving component 120 can be driven to swing about the first axis P1 by the time-varied magnetic force and the optical reflector 130 can be enabled to swing about the second axis P2 by the Lorentz force.

Substantially, there is a 45-degree included angle formed between the direction of the first magnetic field F1′ and the first axis P1. In detail, the driving magnetic field generator 350 includes a pair of first magnets 352, being disposed respectively at two opposite corners on the frame 122, as shown in FIG. 3, so as to cause the direction of a first magnetic filed F1′ generated thereby to form an included angle of 45 degrees with the first axis P1.

Consequently, a component of the first magnetic field F1′ can be used for generating the time-varied magnetic force for driving the driving component 120 to swing while the rest component can be used for generating the Lorentz force for driving the optical reflector 13 to swing. Thereby, substantially, the optical reflector 130 is enabled to swing about the first axis P1 and also the second axis P2 for enabling its reflective surface 132 to reflect light toward a screen, and thus, forming images.

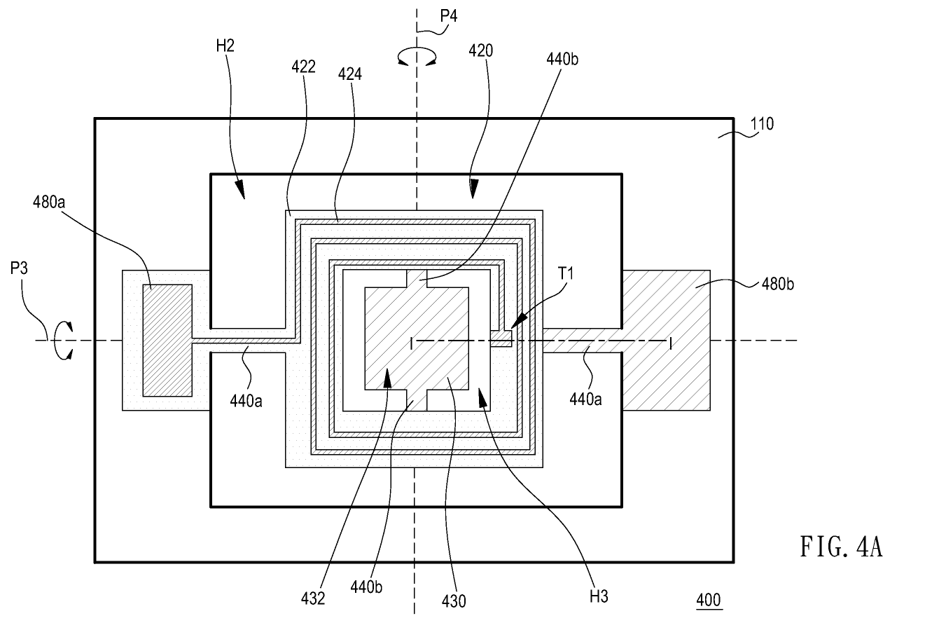

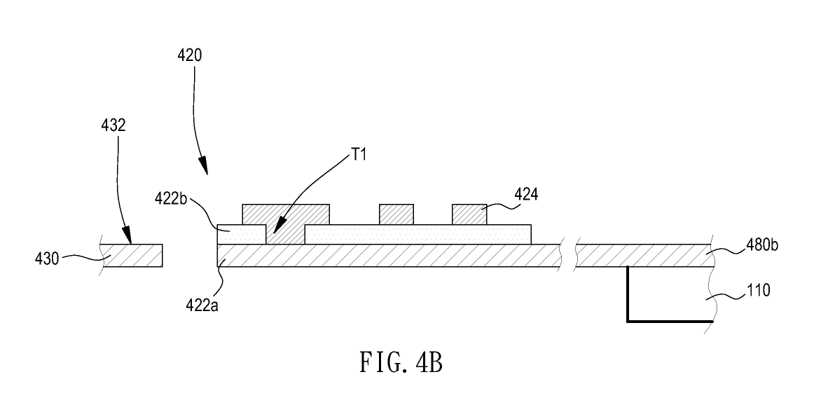

FIG. 4A is a top view of an optical scanner according to further another embodiment of the invention, and FIG. 4B is an I-I sectional view of FIG. 4A. As shown in FIG. 4A and FIG. 4B, the optical scanner 400 comprises: a substrate 110; a driving component 420; and an optical reflector 430, in which the driving component 420 is disposed on the substrate 110 and is configured with a first hole H3 to be used for receiving the optical reflector 430 therein.

The driving component 42 includes a frame 422 and a coil circuit 424, in which the frame 422 is further configured with a metal layer 422a and a insulation layer 422b disposed on the metal layer 422a. Moreover, the insulation layer 422b, is configured with a via hole T1 and the coil circuit 424 is disposed on the insulation layer 422b in a manner that it is formed surrounding the first hole H3 while electrically connecting to the metal layer 422a through via hole T1, as shown in FIG. 4B. In addition, the frame 422 is disposed at a position corresponding to the second hole H2 of the substrate 110.

By the aforesaid structure, the driving component 420 is enabled to swing about the first axis P3 and the optical reflector 430 is enabled to swing about the second axis P4, whereas the first axis P3 is disposed perpendicular to the second axis P4, while both the first axis P3 and the second axis P4 are arranged parallel with the reflective surface 432 of the optical reflector 430. Therefore, by the swing of the driving component 420 and the optical reflector 430, the reflective surface 432 is able to reflect light toward a screen, and thus, forming images.

In this embodiment, the optical scanner 400 further comprises a pair of first arms 440a and a pair of second arms 440b. It is noted that each of the first arms 440a is disposed coaxially to the first axis P3 to be used for connecting the frame 422 to the substrate 110, by that the driving component 420 is able to swing about the two first arms 140a as the pair of the first arms 440a is able to function as the first axis P3. Similarly, each of the second arms 440b is disposed coaxially to the second axis P4 to be used for connecting the frame 422 to the optical reflector 430, by that the optical reflector 430 is able to swing about the two second arms 440b since the second arms 140b are designed to function as the second axis P4.

In addition, the insulation layer 442b can be made of a material selected from the group consisting of: Si₃N₄, SiO₂, a photo resist, epoxy, and polyimide (PI); and the via hole T1 is formed by the use of a means selected from the group consisting of: dry etching, wet etching and laser drilling. Moreover, the metal layer 422a, being a magnetic layer, can be made of a permanent magnet and capable of emitting a permanent magnetic field.

In detail, the aforesaid magnetic layer, i.e. the metal layer 422a, is made of a hard magnetic material, such as CoNiMnP, PtCO/Ag, Pt/Fe, CoCrTaₓ and FeCrCo, which is a magnetic material capable of emitting a larger than 200 oersteds (Oe) coercive field and also capable of maintaining a permanent magnetic field after being magnetized. Thereby, the driving component 420 can be driven to swing by a time-varied magnetic force.

It is note that the optical reflector 430 and the metal layer 422a can be formed by lithograph processing and etching on a metal layer, that is, the optical reflector 430 and the metal layer 422a can be formed simultaneously on the same metal layer and thus they are made of the same material. As the metal layer 422 is made of a hard magnetic material, the optical reflector 430 is also made of the same hard magnetic material so that it is also being a permanent magnetic layer.

The optical scanner 400 further comprises a first electrode 480a and a second electrode 480b, in which the first electrode 480a is electrically connected to the coil circuit 424 and the second electrode 480b is electrically connected to the metal layer 422a. Moreover, the first electrode 480a and the second electrode 480b are respectively disposed at two opposite sides of the frame 422 while being exposed for enabling one of the two first arm 440a to be sandwiched between the first electrode 480a and the frame 422 and another first arm 440a to be e sandwiched between the second electrode 480b.

As the first electrode 480a and the second electrode 480b are connected to an external power source, current from the external power source can flow through the coil circuit 424 and the metal layer 422a for causing the coil circuit to generate magnetic field and thus generate the Lorentz force for driving the driving component 420 to swing.

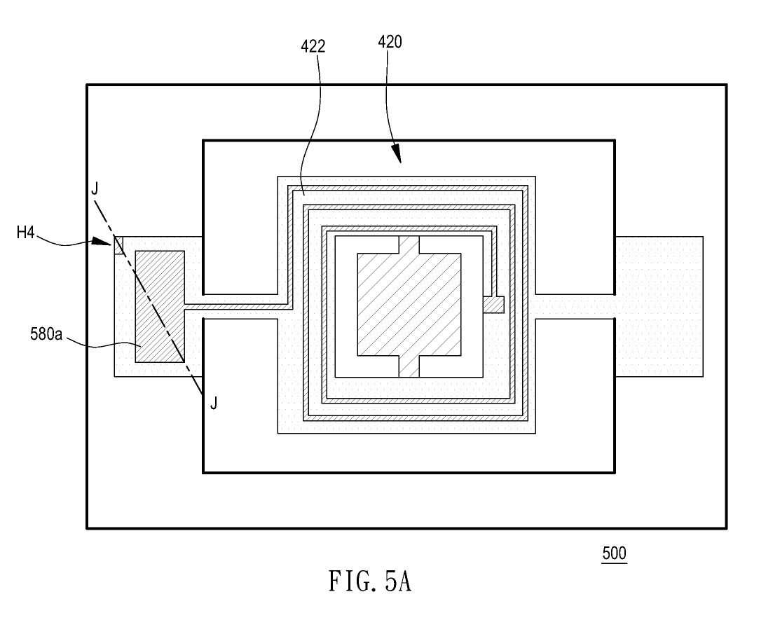

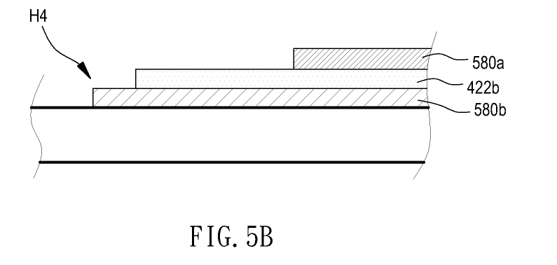

FIG. 5A is a top view of an optical scanner according to further another embodiment of the invention. FIG. 5B is a J-J sectional view of FIG. 5A. As shown in FIG. 5A and FIG. 5B, the optical scanner 500 is structured similar to the aforesaid optical scanner 400, but is different in that: the first electrode 580a and the second electrode 580b are configured in the optical scanner 500 at positions located at the same side of the frame 422.

In detail, the first electrode 580a is located at a position opposite to that of the second electrode 580b, by that the insulation layer 422b of the frame 422 in the driving component 420 of the optical scanner 500 is disposed sandwiching between the first electrode 580a and the second electrode 580b. Moreover, the optical scanner 500 further comprises a pair of first arms 440a and a pair of second arms 440b, and one of the pair of first arms 580a, being disposed between the first electrode 580a and the frame 422, is also sandwiched between the second electrode 580b and the frame 422.

The insulation layer 422b is further configured with an opening H4 from which a portion of the second electrode 580b is exposed. Through the opening H4, both the first electrode 580a and the second electrode 580b can be connected electrically to an external power source for enabling current to flow from the external power source to the driving component 420 to be used for generating a magnetic field, and thereby a Lorentz force can be caused for driving the driving component 420 to swing accordingly. Moreover, as the opening H4 is formed in a manner similar to the via hole T1 in the previous embodiment, it is not described further herein.

To sum up, the optical reflector of the present invention is designed with an optical reflector capable of being driven to swing about two mutually perpendicular rotation shafts, such the first axis P1, P3 and second axes P2, P4, by the time-varied magnetic force and the Lorentz force, and thereby, the beams reflected by the optical reflector can be used in a vertical scanning as well as a horizontal scanning so as to project an image on a screen.

With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

What is claimed is:

1. An optical scanner, comprising:
a substrate;
a driving component, configured with a first hole and disposed on the substrate for enabling the same to swing about a first axis by a time-varied magnetic force; and
an optical reflector, configured with a reflective surface and disposed in the first hole for enabling the same to swing about a second axis by a Lorentz force;
wherein, the first axis is essentially perpendicular to the second axis, and the first axis and the second axis are both essentially parallel to the reflective surface.

2. The optical scanner of claim 1, wherein the driving component further comprise:
a frame; and
a coil circuit, disposed on the frame and surrounding the first hole.

3. The optical scanner of claim 1, wherein the substrate is a component selected from the group consisting of: a silicon substrate, a glass substrate, and a circuit board.

4. The optical scanner of claim 2, wherein the substrate is configured with a second hole at a position corresponding to the frame.

5. The optical scanner of claim 2, further comprising:
a pair of first arms, disposed coaxially to the first axis to be used for connecting the frame to the substrate.

6. The optical scanner of claim 5, further comprising:
a pair of second arms, disposed coaxially to the second axis to be used for connecting the frame to the optical reflector.

7. The optical scanner of claim 2, further comprising:
a first magnetic field generator, disposed under the driving component for enabling the time-varied magnetic force to be generated at a position between the first magnetic field generator and the driving component.

8. The optical scanner of claim 7, wherein the first magnetic field generator is a coil.

9. The optical scanner of claim 7, wherein there is an internal magnetic field existed inside the frame whose direction is parallel to the second axis.

10. The optical scanner of claim 9, wherein the frame is made of a material selected from the group consisting of: a ferromagnetic material and a ferrimagnetic material.

11. The optical scanner of claim 9, wherein the frame is a permanent magnet.

12. The optical scanner of claim 9, further comprising:
a driving magnetic field generator, capable of causing the Lorentz force to be generated at a position between the coil circuit and the driving magnetic field generator and thus enabling the optical reflector to be driven to swing about the second axis by the Lorentz force.

13. The optical scanner of claim 12, wherein the driving magnetic field generator further comprising:
a pair of first magnets, provided for generating a first magnetic filed at a position between the same to be used for causing the Lorentz force.

14. The optical scanner of claim 13, wherein the internal magnetic field is caused by the induction of the first magnetic field.

15. The optical scanner of claim 14, wherein there is a 45-degree included angle formed between the direction of the first magnetic field and the first axis.

16. The optical scanner of claim 13, wherein the direction of the first magnetic field is parallel to the first axis.

17. The optical scanner of claim 16, further comprising:
a second magnetic field generator, provided for generating a second magnetic filed to be used for causing the internal magnetic field by the induction of the second magnetic field.

18. The optical scanner of claim 17, wherein the second magnetic field generator further comprising:
a pair of second magnets, provided for generating the second magnetic filed at a position between the same.

19. The optical scanner of claim 17, wherein the direction of the second magnetic field is parallel to the second axis.

20. An optical scanner, comprising:
a substrate;
a driving component, disposed on the substrate and configured with a first hole, further comprising:
a frame, composed of a metal layer and an insulation layer in a manner that the insulation layer being configured with a via hole is disposed on the metal layer; and
a coil circuit, disposed on the insulation layer and surrounding the first hole while electrically connecting with the metal layer through the via hole;
and
an optical reflector, disposed in the first hole.

21. The optical scanner of claim 20, wherein the driving component is enabled to swing about a first axis, and the optical reflector, being configured with a reflective surface, is enabled to swing about a second axis, as the first axis is disposed perpendicular to the second axis and both the first and the second axes are disposed parallel to the reflective surface.

22. The optical scanner of claim 20, wherein the substrate is configured with a second hole at a position corresponding to the frame.

23. The optical scanner of claim 20, further comprising:
a pair of first arms, disposed coaxially to the first axis to be used for connecting the frame to the substrate.

24. The optical scanner of claim 23, further comprising:
a pair of second arms, disposed coaxially to the second axis to be used for connecting the frame to the optical reflector.

25. The optical scanner of claim 23, further comprising:
a first electrode, electrically connected to the coil circuit; and
a second electrode, electrically connected to the metal layer.

26. The optical scanner of claim 25, wherein the first and the second electrodes are respectively disposed at two opposite sides of the frame while being exposed.

27. The optical scanner of claim 26, wherein one of the two first arms is disposed between the first electrode and the frame while disposing another arm in the pair between the second electrode and the frame.

28. The optical scanner of claim 25, wherein the first and the second electrodes are disposed at a same side of the frame while allowing the insulation layer to be disposed between the first and the second electrodes as the insulation layer is further configured with an opening from which a portion of the second electrode is exposed.

29. The optical scanner of claim 28, wherein one of the two first arms being disposed between the first electrode and the frame is also disposed between the second electrode and the frame.

30. The optical scanner of claim 20, wherein the insulation layer is made of a material selected from the group consisting of: Si₃N₄, SiO₂, a photo resist, epoxy, and polyimide (PI).

31. The optical scanner of claim 20, wherein the optical reflector is a magnetic layer.

32. The optical scanner of claim 31, wherein the magnetic layer is a permanent magnetic field source.

33. The optical scanner of claim 32, wherein the metal layer and the magnetic layer are made of the same material.

34. The optical scanner of claim 31, wherein the magnetic layer is made of a hard magnetic material.

35. The optical scanner of claim 34, wherein the hard magnetic material is a material selected from the group consisting of: CoNiMnP, PtCO/Ag, Pt/Fe, CoCrTaₓ and FeCrCo.
